(19) United States
(12) Patent Application Publication
(10) Pub. No.: US 2005/0236521 A1
(43) Pub. Date: Oct. 27, 2005

(54) Securing apparatus for a portable electronic unit

(76) Inventors: Helmut Krause, Stuttgart (DE); Ingo Kolsch, Schoenaich (DE); Karl-Heinz Preis, Heidenheim (DE); Alexander Litz, Koenigsbronn (DE)

Correspondence Address: Donald S. Showalter;Holland & Knight LLP, One East Broward Boulevard, Suite 1300, P.O. Box 14070, Ft. Lauderdale, FL, 33302-4070, US

(21) Appl. No.: 11/084,559

(22) Filed: Mar. 18, 2005

(30) Foreign Application Priority Data
Mar. 20, 2004 (DE) 10 2004 013 875.3

(51) Int. Cl. B64C 1/20

(52) U.S. Cl. 244/118.1

(57) ABSTRACT

The invention relates to a securing apparatus for a portable electronic unit to an adapter, which is electronically and/or mechanically connected to a physical unit, in particular an aircraft. The adapter is provided with a locking device which has a control element that is mounted via a shaft, with the shaft being provided with an eccentric device, and with the eccentric device pushing the portable device (which is inserted into the adapter) to a vibration-proof locked position by operation of the control element beyond the dead point of the eccentric device.

### BACKGROUND OF THE INVENTION

1. Field of the Invention

The invention relates to a securing apparatus for a portable electronic unit to an adapter, which is electrically and/or mechanically connected to a physical unit.

The invention also relates to a securing apparatus for a portable storage device in an aircraft.

2. Description of the Related Art

Various portable electronic units are known from the general prior art which can be connected to a physical unit for expedient use. The portable electronic units may, for example, be portable computer systems or individual system modules, such as a portable storage medium. The portable units may, for example, also be in the form of electronic modules, that is instruments, medical appliances and the like.

The physical unit may, for example, be in the form of land vehicles, marine vessels or aircraft.

If the portable electronic unit is a laptop adapters are known for connection to a land vehicle. In this case, the adapters allow the laptop to be fixed and/or quickly replaced.

The known adapters in this case have the disadvantage that they are cumbersome and difficult to handle. Furthermore, the locking device is not sufficiently well protected against accidental opening in the event of vibrations and impacts.

So-called hard disk stores or flight data recorders are also known from the general prior art, in which the data obtained from a digital camera is stored during a photographic flight of an aircraft. This data may, for example, be photographic data, supplementary data relating to the images, such as mission data, system information, or general information for post processing. The flight data recorder is generally in the form of a bulk store for a digital mapping camera.

Electrically and mechanically, every flight data recorder is an autonomous unit, which is connected to the digital camera via a photographic data connection.

In the aircraft, each storage device is mechanically secured, and in a further process is electrically connected to all the necessary cables. The flight data recorder stores the photographic data during the flight. After landing, the flight data recorder is removed and the photographic data is copied to a ground-based bulk memory. Since the space in the aircraft is highly confined, and the flight data recorder must be installed at different locations depending on the aircraft type and the camera installation situation, the apparatus for securing the flight data recorder is subject to particularly demanding requirements. The flight data recorder should be convenient to replace, as far as possible without the use of any additional tool.

The apparatuses which are known from the general prior art for securing a flight data recorder are complex to handle and generally require an additional tool in order to connect or to screw the portable unit firmly and reliably to the aircraft. Furthermore, the connection of the contact elements of the flight data recorder to the corresponding cables which continue further is tedious, and is often very difficult owing to the confined spatial conditions in the aircraft. This is particularly true for high data transmission rates. Incorrect connection of cables can in this case quickly lead to a malfunction. It is particularly important for the portable unit to be kept connected to the aircraft in a robust form since, otherwise, movements of the aircraft during flight may result in a risk of the flight data recorder accidentally becoming loose or in the cable connections becoming loose.

### SUMMARY OF THE INVENTION

The present invention is thus based on the object of providing a securing apparatus for a portable electronic unit and/or a storage device in an aircraft which overcomes the abovementioned disadvantages of the prior art and which, in particular, can be operated easily, is reliable and is proof against vibration and impacts.

According to the invention, this object is achieved by the characterizing part of claim 1.

According to the invention, this object is also achieved by the characterizing part of claim 23.

The solution according to the invention as claimed in claim 1 makes it possible to push the portable unit to a secured position in a simple manner and to fix it there in such a manner that the apparatus cannot become loose on its own. The process of pushing in and fixing the portable device in the adapter can be carried out with one hand by virtue of the solution according to the invention. In order to push the portable unit in and to lock it, the unit must be inserted into the adapter in an intended position in a first step. The control element is then operated in order to rotate the shaft which is provided with the eccentric device, such that the eccentric device makes contact with the portable unit and then pushes it to a secured position. In the process, the eccentric device pushes the portable unit which has been inserted into the adapter beyond the dead point of the eccentric to the secured position. This ensures that the portable unit will no longer move on its own in the opposite direction.

Any movement of the portable unit in the opposite direction to the insertion direction leads to the locking device being secured even more firmly owing to the fact that the eccentric has been moved beyond the dead point.

It is advantageous for the adapter and the portable unit each to have connecting-link elements which can be moved with respect to one another in order to assume the secured position, and can be clamped and wedged to one another in the secured position.

The connecting-link elements may in this case preferably be in the form of protrusions which are aligned with one another and can be moved into one another and with respect to one another by means of the insertion movement. The connecting-link elements may in this case be connected to one another on the basis of a tongue and groove connection principle, with the connecting-link element, which is in the form of a tongue being moved into the connecting-link element which is in the form of a groove as a result of the insertion movement and the relative movement of the portable unit with respect to the adapter. It is advantageous for the adapter to have side guides which extend upward from a bottom surface of the adapter and surround at least one lower area of the portable unit, which has been inserted into the adapter, at the sides.

The side guides fix the portable unit at the sides. In this case, it is also possible to provide for the connecting-link elements on the adapter side to be arranged on the inside of the side guides. Arrangement of the connecting-link elements of the portable unit on its outside in an area which is surrounded by the side guides of the adapter results in robust guidance for the portable unit. Operation of the control element results in the portable unit being pushed to the locked position in a stable and secure manner by means of the side guides and the connecting-link elements which point toward one another.

One design refinement of the invention makes it possible to provide for the eccentric device to have two eccentric elements or pressure pieces which are each arranged in the area of one end of the shaft. In this case, each eccentric element may be associated with a horizontal and a vertical contact surface on the portable unit. The eccentric elements are preferably in this case in the form of curved rings which are arranged eccentrically on the shaft and each have two radially projecting projections.

As has been found from numerical simulations and experiments, the rotary movement of the shaft can be transferred in a simple manner to a linear movement of the portable unit, when an eccentric element is arranged at each end of the shaft.

The eccentric device may, of course, also have more or less than two eccentric elements. In this case, it is possible to provide, for example, only one eccentric element, which is arranged in the center of the shaft. In contrast to the arrangement of two eccentric elements in each case at the shaft end, in the case of the arrangement of a central eccentric element, there is no need to ensure identical installation and identical alignment of the eccentric elements (in order that the eccentric elements do not jam or are not supported on one side).

Since the eccentric elements have two radially projecting projections, an advantageously two-stage movement sequence can be transferred to the portable unit. In this case, it is advantageous if, in the first stage of the rotary movement of the shaft, the respective projections on the eccentric elements which are in each case located at the front in the rotation direction of the shaft make contact with the respectively associated vertical contact surfaces of the portable unit, and push the portable unit to the secured position. The vertical contact surfaces of the portable unit are suitable in a particularly simple manner for conversion of the rotary movement of the two eccentric elements which is introduced via the shaft to a horizontal movement of the portable unit, so that the latter can be pushed to the intended secured position. Once the portable unit has reached the secured position, the design provides that the respective projections of the eccentric elements which are in each case located at the rear in the rotation direction of the shaft make contact with the horizontal contact surfaces of the portable unit and raise the portable unit in such a way that the portable unit is clamped or braced at right angles to the insertion direction. The connecting-link elements on the adapter and on the flight data recorder, and the eccentric elements, interact appropriately for this purpose. The horizontal contact surfaces of the portable unit are in this case suitable in a particularly simple manner for raising the portable unit and for pushing it in the vertical direction.

As the inventor has found in a manner which is not obvious, the two-stage movement sequence which is transferred by the eccentric elements to the portable unit allows the portable unit to be pushed into the adapter easily. The portable unit is then locked without having to take any further actions. All that is required to operate the apparatus according to the invention is to operate the control lever by means of which the shaft, and thus the eccentric elements as well, is rotated. In order to initiate the two stages of the rotary movement, the user just has to move the control lever from an initial position to a final position. There is no need for any further work steps. The mimic of the control lever results in a high locking force being produced from only a small operating force.

In a development of the invention, it has advantageously been found that the connecting-link elements which are in the form of wedges can be arranged with respect to one another such that they are clamped or wedged to one another by the raising of the portable unit. The contact surfaces of the connecting-link elements which point toward one another may in this case preferably be in the form of wedges. The connecting-link elements which are in the form of wedges are in this case designed and arranged such that they can be raised only as far as a specific point. Since the two eccentric elements push the portable unit upward, but the connecting-link elements of the adapter prevent further raising beyond a predetermined end point, the portable unit is fixed to the adapter firmly and such that it cannot be moved. The connecting-link elements which are attached immovably to the adapter and to the flight data recorder, and the control lever which moves the eccentric device then interact in order to fix the adapter. The operation of the control lever raises the entire flight data recorder and thus the connecting-link elements which are firmly connected to it as well.

In this case, the invention provides for the eccentric elements to raise the portable unit at one end. Raising the portable unit at only one end moves it to a slightly inclined position, so that the portable unit is fixed in both main directions by interaction with the connecting-link elements.

It is advantageous for the shaft to be arranged on at least one spring element which prestresses the shaft essentially vertically in the direction of the horizontal contact surfaces. In this case, it is particular suitable for the spring elements to be in the form of plate springs. Arranging the shaft on at least one prestressed spring element improves the reliability against wear and against tolerance errors. The prestressing of the shaft ensures that the projections on the eccentric elements which are located at the rear in the rotation direction are still able even after corresponding wear to make contact with the associated horizontal contact surfaces of the portable unit in order to raise the portable unit and thus to lock it. In principle, a correspondingly elastic or flexible shaft can also be used for this purpose. However, a shaft such as this generally has the same stiffness in the horizontal and vertical directions. However, the inventor has found that high stiffness of the shaft in the horizontal direction and a certain amount of elasticity of the shaft in the vertical direction (in order to compensate for tolerance errors and wear) are particularly suitable. Such different stiffness of the shaft in the horizontal and vertical direction can advantageously be achieved on the one hand by the shaft having a rectangular cross section, and on the other hand by the shaft resting on the prestressed spring in the vertical direction, and being guided at the sides. The spring is preferably in this case adapted such that it flexes only beyond a specific compression load. The compression load beyond which the spring flexes, with the shaft in consequence moving in the direction of the spring, is preferably chosen such that normal vibration and impacts do not lead to movement of the spring. The shaft is thus not elastic in response to normal vibration. This avoids any self-oscillation of the portable unit.

In the stated refinement, in which the shaft rests on prestressed plate springs, it has been found to be particularly suitable for the shaft to be stiff or very stiff. Analyses and experiments have likewise shown a refinement of the shaft with a rectangular cross section to be advantageous.

In one design refinement of the invention, it is also possible to provide for the adapter and the portable unit to be provided with electrical coupling elements which make contact with one another in the secured position. This advantageously means that there is no longer any need to manually plug on the cables which are required for connection of the portable unit.

An apparatus according to the invention for securing a portable storage device in an aircraft results from the distinguishing part of claim 23 and, with regard to advantageous embodiments, from the further claims which relate to it. In this case, claim 1 and the further claims which refer back to it result in a particularly advantageous locking device for the storage device to be fitted in an aircraft.

The solution according to the invention which results from claim 23 facilitates a securing arrangement for a storage device in an aircraft that can be operated easily, is reliable and is proof against impacts. In this case, an adapter which is suitable for holding the storage device is electronically and mechanically connected to the aircraft. In order to fit the storage device, it need no longer be mechanically screwed to the aircraft at some point, as in the past, but can simply be inserted into the adapter that is provided. In this case, provision is also made for the adapter and the storage device to be provided with electronic coupling elements, which make contact with one another in the secured position. Use of an adapter for securing a storage device in an aircraft is not known from the prior art, but results in enormous advantages over a simple screw connection since a reliable and impact-resistant connection is in fact a major factor in aircraft. It is also advantageous in this case that there is no need for the previously tedious and difficult plugging on and connection of cables.

It is advantageous for the storage device to be in the form of a flight data recorder, in which data obtained from a digital camera can be stored when the aircraft is making a photographic flight.

Advantageous developments and refinements of the invention can be found in the other dependent claims. One exemplary embodiment of the invention will be described, fundamentally, in the following text with reference to the drawings.

### BRIEF DESCRIPTION OF THE DRAWINGS

FIG. 1 shows a perspective illustration of an adapter with a portable unit which has been inserted and locked;

FIG. 2 shows the portable unit illustrated in FIG. 1, illustrated on its own;

FIG. 3 shows a perspective illustration of the locking device for the adapter;

FIG. 4 shows a schematic illustration of the shaft of the locking device, which is prestressed by spring elements in the vertical direction;

FIG. 5 shows a comparison of the fundamental characteristics between an elastic or flexible shaft and a stiff shaft, which is mounted as shown in FIG. 4;

FIG. 6 shows an illustration of an adapter with a portable unit inserted, in the unlocked state;

FIG. 7 shows an illustration corresponding to FIG. 6, with the portable unit having already been pushed in the direction of the locked position;

FIG. 8 shows an illustration corresponding to FIG. 6 and FIG. 7, with the portable unit having reached the locked position;

FIGS. 9a to 9g show a schematic detailed illustration of an eccentric element and of the contact surfaces of the portable unit during the locking process, and

FIG. 10 shows an internal view of the flight data recorder with two storage media which are connected to the inside of the housing of the flight data recorder via a supporting structure, with vibration damping.

### DETAILED DESCRIPTION

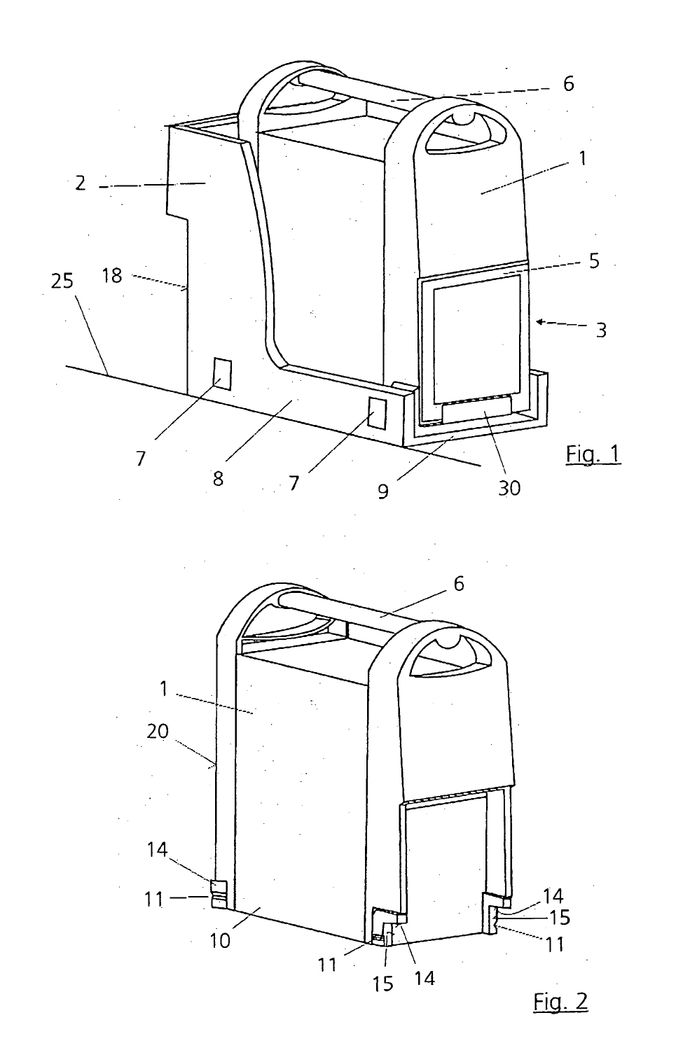

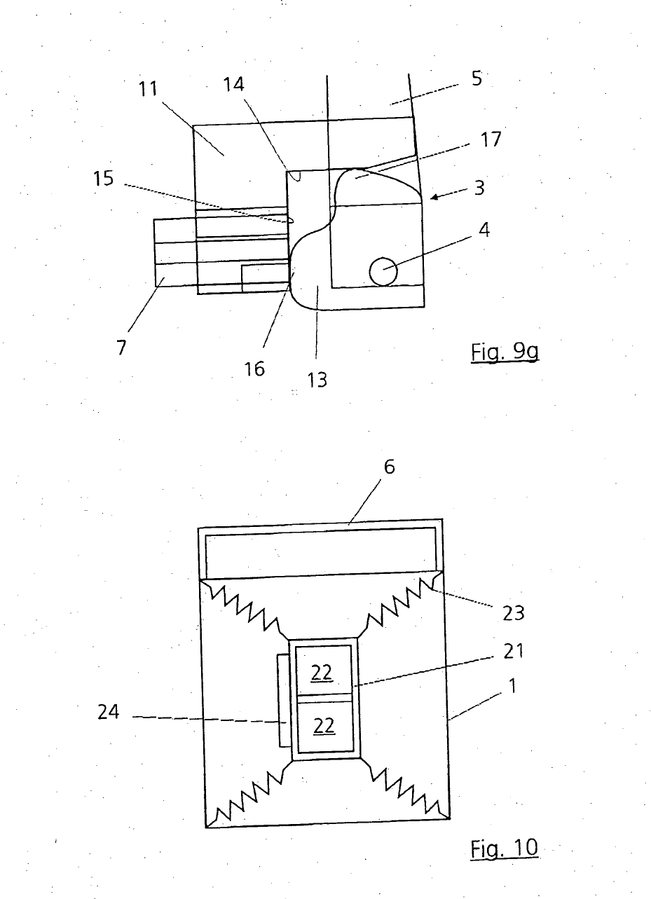

FIG. 1 shows the apparatus according to the invention for securing a portable electronic unit 1 on an adapter 2. The adapter 2 is in this case electrically and/or mechanically connected to a physical unit, which is not illustrated in any more detail. The exemplary embodiment in this case provides for the portable electronic unit to be a storage device in the form of a hard disk store or a flight data recorder 1. The flight data recorder 1 is in this case used to store data obtained from a digital camera (which is not illustrated) during a photographic flight by an aircraft 25. The flight data recorder 1 may in this case, for example, contain two or more storage media (for example hard disks) and possibly further system components (for example a controller) (see FIG. 10).

Digital cameras for recording such data have been known for a long time from the general prior art, and they will therefore not be described in any more detail in the exemplary embodiment.

Fundamentally, the apparatus according to the invention is suitable for use in widely differing fields in which reliable fixing is required between a portable unit 1 and an adapter 2, even in rugged environmental conditions, for example in military operations or in general, for land vehicles, marine vessels or aircraft. The apparatus according to the invention can be used in a particularly preferable manner when the portable unit is in the form of a portable computer system or is part of a computer system, for example a hard disk store, which is subject to impacts, vibration or oscillations while being read from or written to.

Where the elements illustrated in the exemplary embodiment are already known from the general prior art, they will not be described in any more detail here. The following text describes in more detail only those features which are significant to the invention.

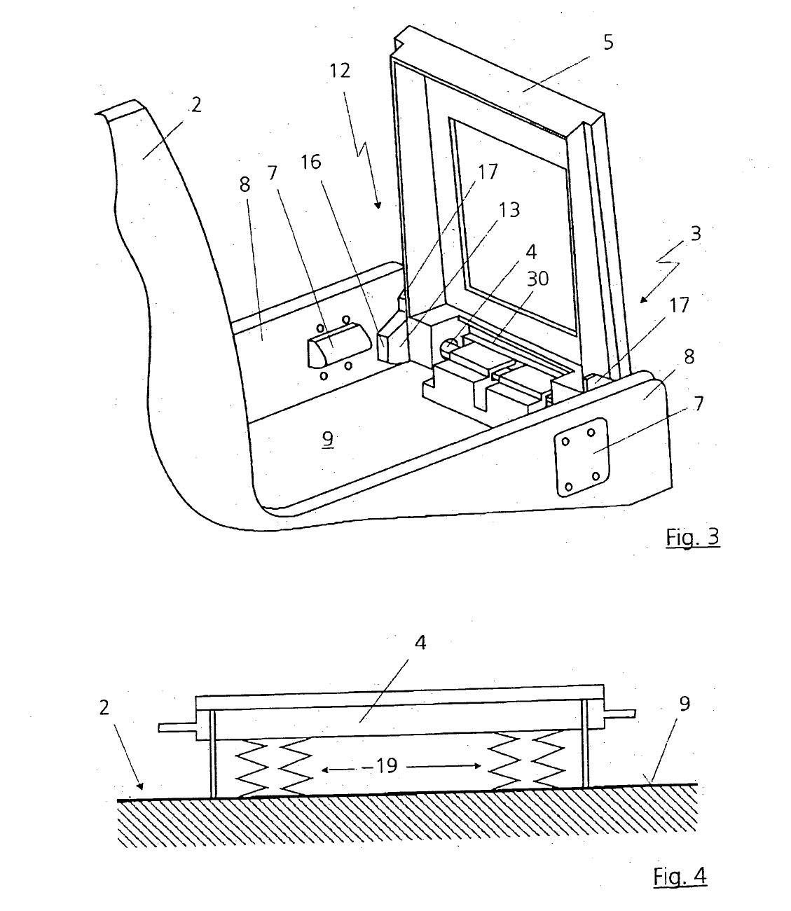

As can be seen from FIG. 1, the flight data recorder 1 (which is externally essentially in the form of a housing) is connected or braced to the adapter 2 by means of a locking device 3. In this case, as can be seen in detail from FIG. 3, the locking device 3 has a control element 5 which is mounted via an axle or a shaft 4. The control element in the exemplary embodiment is in the form of a manually operable control lever 5 which allows the shaft 4 to be rotated with a reasonable lever force in terms of the ergonomic requirements, which is converted to a much greater bracing force. In alternative embodiments, the control element 5 may, for example, also be in the form of an electric motor or the like, which causes the shaft 4 to rotate. For simple handling and for insertion of the flight data recorder 1, it is provided with a handle 6 on its top face. If two or more storage media are arranged in the flight data recorder 1, then these are combined to form a replaceable unit by means of the handle 6 and/or the housing of the flight data recorder 1.

Electrically and mechanically, the flight data recorder 1 is in the form of an autonomous unit, which is connected to a digital camera via an image data connection. Furthermore, a monitoring data input, a monitoring data output, a supply voltage input, a supply voltage output and a serial connection for a RAID configuration are provided.

According to the invention, it is possible to provide for the flight data recorder to have or include a storage medium or two or more storage media and/or further system components. The exemplary embodiment provides, although this is not illustrated, for two or more storage media to be arranged in the housing of the flight data recorder 1. In this case, the storage media are advantageously arranged in the housing with vibration damping. The storage media are arranged in one or more supporting structures which are connected to the inside of the housing of the flight data recorder via a damping device, with vibration damping.

As can also be seen from FIG. 1, the locking device 1 has a bearing block 30, which is shown in detail in FIG. 3, as the bearing for the shaft 4.

The adapter 2 in the exemplary embodiment has four connecting-link elements 7, of which two can be seen in an illustration from the rear in FIG. 2. The adapter 2 in this case has side guides 8, which extend upward from a bottom surface 9 of the adapter 2 and surround at least a lower area 10 of the flight data recorder 1, which has been inserted into the adapter 2, at the sides. The flight data recorder 1 is in this case illustrated in detail in FIG. 2.

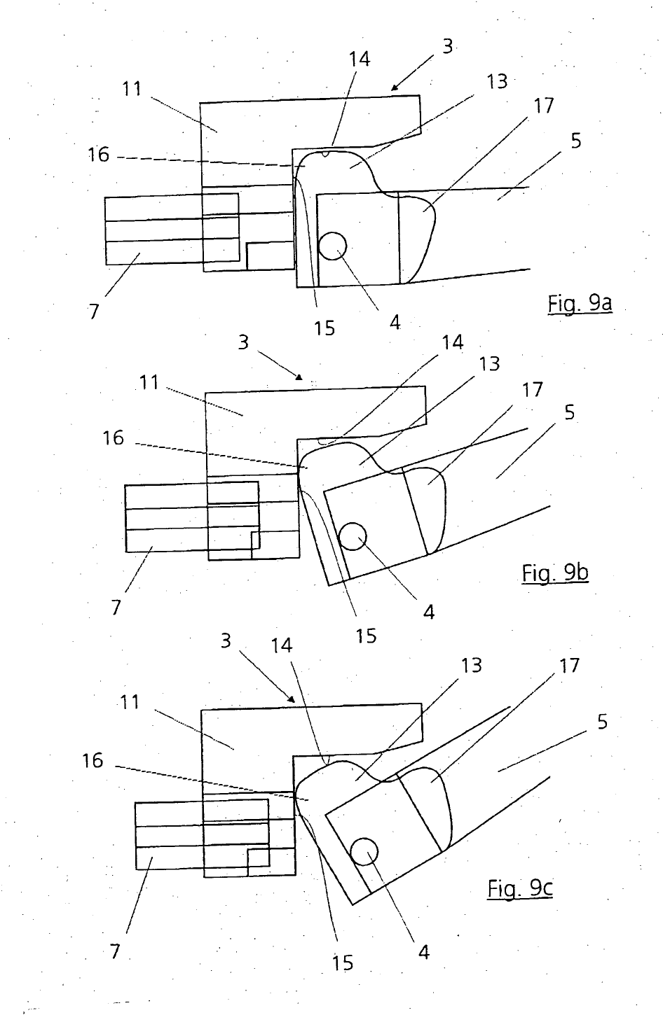

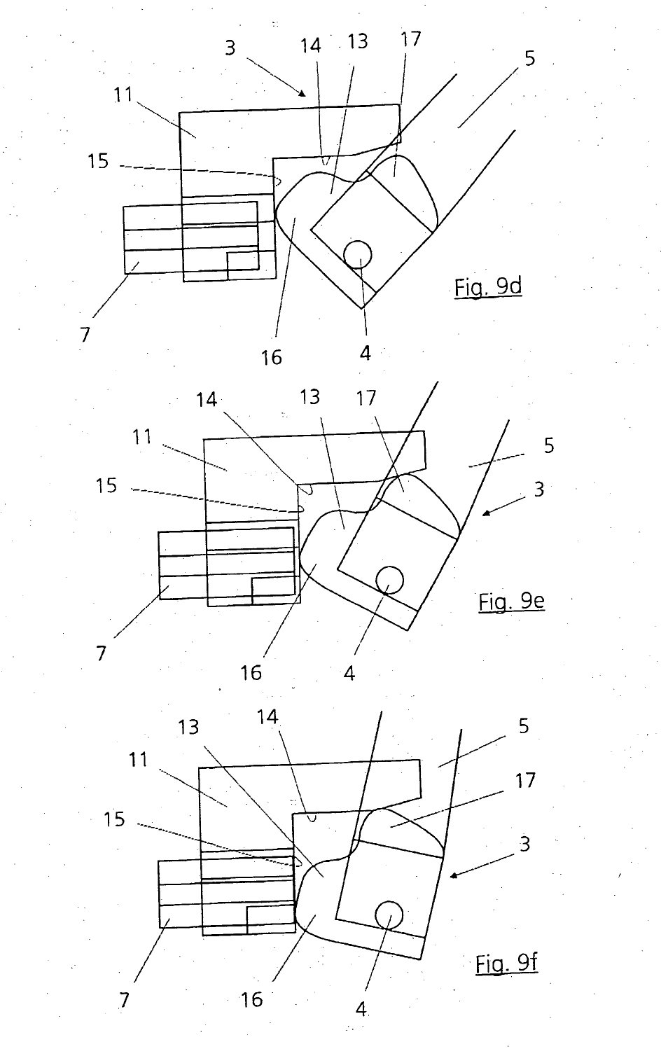

Analogously to the connecting-link elements 7 of the adapter 2, the flight data recorder 1 likewise has four connecting-link elements 11. The connecting-link elements 7, 11 are in this case arranged with respect to one another such that they are moved with respect to one another when the flight data recorder 1 is pushed into the secured position. As can be seen from a combination of FIG. 2 and FIG. 3, as well as the illustrations shown in FIG. 9a to FIG. 9g, the connecting-link elements 11 are in the form of a groove into which the connecting-link elements 7 can be inserted. For this purpose, the connecting-link elements 7 have a tongue or are in the form of wedge-shaped rails. The contact surfaces of the connecting-link elements 7, 11 which point toward one another are in the form of wedges.

The connecting-link elements 7 of the adapter 2 are arranged on the inside of the side guides 8. The connecting-link elements 11 of the flight data recorder 1 are arranged on the outside of the flight data recorder 1, in the area of the lower end 10. As can be seen from FIG. 3 and FIGS. 6 to 8, the shaft 4 is provided with an eccentric device 12. The eccentric device 12 pushes the flight data recorder 1, which has been inserted into the adapter 2, beyond the dead point of the eccentric device 12, to a secured position, by operation of the control lever 5. The fundamental securing process is in this case evident from FIGS. 6 to 8 and, in detail, from FIGS. 9a to 9g.

The eccentric device 12 has two eccentric elements 13, which are each arranged in the area of one end of the shaft 4. FIGS. 9a to 9g in this case show an eccentric element 13 arranged at one shaft end. Each eccentric element 13 is associated with a horizontal contact surface 14 and a vertical contact surface 15 of the flight data recorder 1. The eccentric elements each have two projections 16, 17. In the exemplary embodiment, the eccentric elements 13 are in the form of curved rings which are arranged eccentrically on the shaft 4 and each have two radially projecting projections 16, 17.

The projections 16, 17 are in this case arranged and/or designed such that the rotary movement of the shaft 4 allows a two-stage movement sequence to be transferred to the flight data recorder 1.

FIGS. 9a to 9g show a connecting-link element 7 (in one refinement in the form of a wedge-shaped strip) which is attached on the adapter side, a connecting-link element 7 which is attached to the flight data recorder 1, an eccentric element 13 as well as the control lever 5 in seven different stages of the locking process. FIG. 9a shows the control lever and thus also the locking device 3 in an initial position. In this case, the control lever 5 is in 0° position. FIG. 9b shows the control lever 5 in a position at an angle of 15° to the locking position. FIG. 9c shows the control lever 5 in a position at an angle of 30° to the initial position. FIG. 9d shows the lever in a position at an angle of 45° to the initial position. FIG. 9e shows the control lever in a position at an angle of 60° to the initial position. FIG. 9f shows the control lever 5 in a position at an angle of 75° to the initial position. FIG. 9g shows the locked state, in which the control lever 5 is in a position at 90° from the initial position.

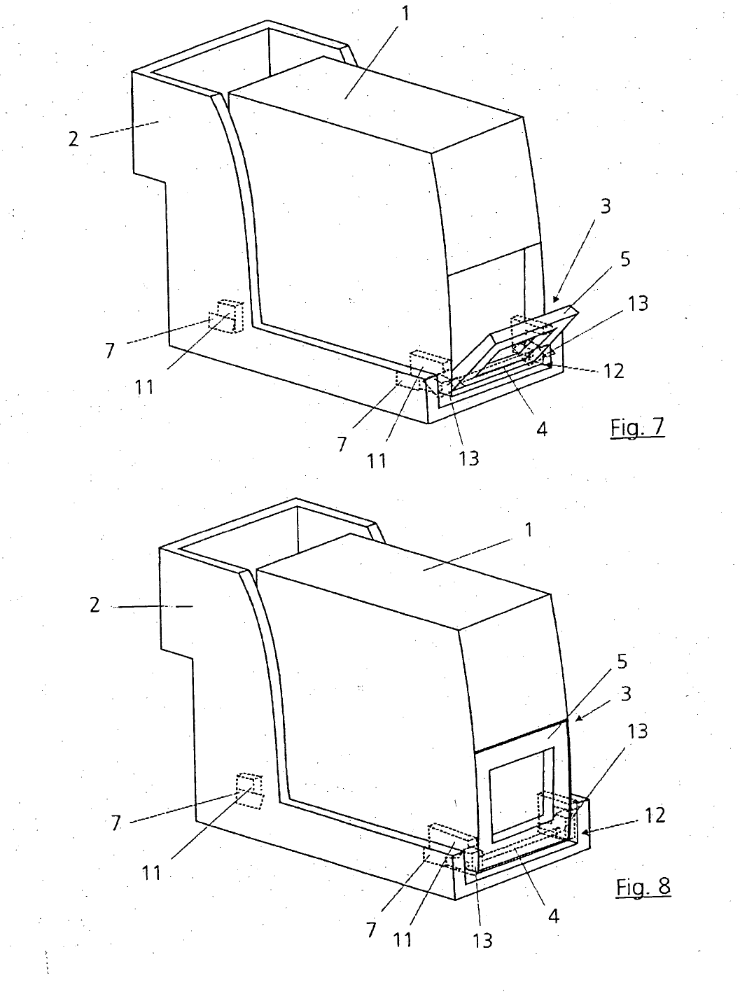

As can be seen from FIG. 7 and FIGS. 9a to 9g, the respective projection 16 of an eccentric element 13 which is located at the front in the rotation direction of the shaft 4 comes into contact in the first stage of the rotary movement with the respectively associated vertical contact surface 15 of the flight data recorder 1. Further rotary movement of the shaft 4 results in the projection 16 being pressed ever more strongly against the vertical contact surface 15, so that the flight data recorder 1 is deflected once the pressure exceeds a certain level, and is thus pushed in the direction of the secured position. The projection. 16 makes contact with the vertical contact surface 15 during this process until the flight data recorder 1 is located in the secured position. Once the secured position has been reached, the second stage of the rotary movement starts, which means that the projection 17 of the eccentric element 13 which is located at the rear in the rotation direction of the shaft 4 now makes contact with the horizontal contact surface 14 of the flight data recorder 1. In consequence, the flight data recorder 1 is raised, and is then clamped such that it is fixed (see FIG. 9g and FIG. 8). During the process, the shaft 4 is rotated by means of the control lever 5 until the rear projection 17 on the eccentric elements 13 is moved beyond its dead point. This results in self-locking.

The raising of the flight data recorder 1 results in the connecting-link elements 11, which are in the form of wedges, of the flight data recorder 1 likewise being raised and being pressed against the connecting-link elements 7, which are likewise in the form of wedges, on the adapter 2, such that they are clamped. The projections 17 on the eccentric elements 13 in this case raise the flight data recorder 1 until the connecting-link elements 11 are pressed against the connecting-link elements 7 without any play. It is therefore no longer possible for the flight data recorder 1 to move vertically with respect to the adapter 2. In this case, it is clamped in such a way that horizontal movement of the flight data recorder 1 with respect to the adapter 2 is also no longer possible. This is assisted by the fact that the connecting elements 7, 11 are in the form of wedges, and the flight data recorder 1 is wedged obliquely against the adapter 2 by being raised at only one of its ends. This results in an oblique plane, which advantageously results in the connecting-link elements 7, 11 being wedged in place.

The invention provides, in a manner which is not illustrated in any more detail, for the adapter 2 to be provided on a rear face 18, which faces away from the locking device 3, with an ejection spring (not illustrated). When the locking device 3 is opened, the ejection spring is intended to assist movement of the flight data recorder 1 in the opposite direction to the insertion direction, so that the flight data recorder 1 can be removed from the adapter 2 in a simple manner. The exemplary embodiment provides (although this is not shown in detail) for the front projections 16 no longer to rest on the vertical contact surfaces 15 when in the secured position. The clamping or the fixing of the flight data recorder 1 to the adapter 2 is thus provided exclusively by the connecting-link elements 7, 11 and/or the rear projections 17 and the horizontal contact surfaces 14. In some circumstances, contact between the front projections 16 and the vertical contact surfaces 15 could in conjunction with the ejection spring result in the system having its own dynamics, which as far as possible should be prevented.

A refinement of the invention which is not illustrated makes it possible to provide for the shaft 4 to be in the form of an elastic or flexible shaft.

The exemplary embodiment shown in FIG. 4 provides for the shaft 4 to be arranged on at least one spring element 19, which prestresses the shaft 4 essentially vertically in the direction of the horizontal contact surfaces 14. In the exemplary embodiment, the spring elements 19 are in the form of two plate spring stacks.

The shaft 4 in this case touches the two plate spring stacks 19, and/or rests on them. The shaft 4 in the exemplary embodiment can thus be in the form of a stiff shaft. This allows the shaft to be designed to have different stiffnesses in the horizontal and vertical directions. Owing to the prestressed plate spring stacks 19, the shaft 14 is designed to be quasi-degressive in the vertical direction, thus resulting in an improvement in the resistance to wear and tolerance errors, because relatively large distance changes lead to relatively small force changes.

High stiffness of the shaft 4 is advantageous in the horizontal direction in order to largely prevent the shaft 4 from moving out of the position in the securing process. In the vertical direction, on the other hand, the elasticity for bracing of the shaft 4 is advantageous, provided that the elasticity from the shaft is used for bracing and the design variant “stiff shaft on an elastic spring” is not used.

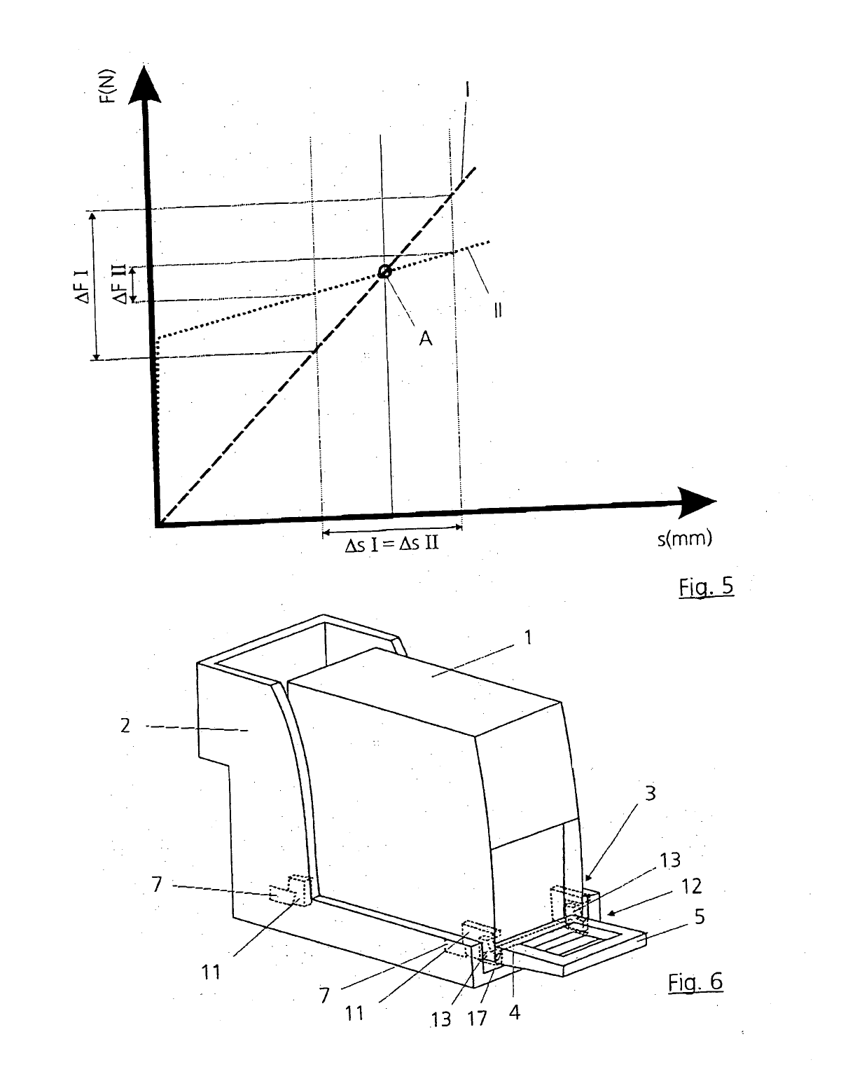

FIG. 5 shows a difference between the characteristics of a flexible shaft, which is not illustrated in the exemplary embodiment, and the illustrated stiff shaft 4, which is mounted via plate spring stacks 19. The characteristic I in this case represents the characteristic for the flexible shaft. The characteristic II represents the characteristic for the stiff shaft 4, which is mounted on plate spring stacks 19. As is illustrated schematically in FIG. 5, the (stress) force on the stiff shaft 4 varies considerably less about the operating point A for the same movement length (ΔSI=ΔSII, but ΔFI>ΔFII). This means that there is considerably less possible loss of stress as a result of wear or tolerances in the case of the stiff shaft 4 (characteristic II).

The plate spring stacks 19 in the exemplary embodiment are designed such that oscillations and vibration which occur during normal flight do not lead to significant movement of the shaft 4. The plate spring stacks 19 flex appropriately, as can be seen from FIG. 5, only beyond a defined force, thus simulating an elastic shaft 4.

The shaft 4 may be mounted, in a manner which is not illustrated, such that it can be moved or adjusted. This provides an individual adjustment capability, if required. The prestress can in this case be set in a simple manner by means of the bearing block 30.

The exemplary embodiment provides for the shaft 4 to have a rectangular cross section.

The invention provides, in a manner which is not illustrated in any more detail, for the adapter 2 and the flight data recorder 1 to have electrical coupling elements, which automatically make contact with one another in the secured position. The electrical coupling elements on the adapter side are in this case arranged in the area of the rear wall 18. The electrical coupling elements of the flight data recorder 1 are preferably arranged on a rear wall 20, which rests on the rear wall 18 of the adapter 2 in the secured position.

It is possible to provide, in a manner which is not illustrated in any more detail, for the control lever 5 to be secured against inadvertent movement in the rest position, that is to say without the flight data recorder 1. This may be achieved, for example, by means of a (leaf) spring which engages in the eccentric device.

Electrically and mechanically, the flight data recorder 1 is in the form of an autonomous unit, which is connected via an image data connection to a digital camera. Furthermore, a monitoring data input, a monitoring data output, a supply voltage input, a supply voltage output and a serial connection for the RAID configuration are provided.

According to the invention, it is possible to provide for the flight data recorder to have or include a storage medium or two or more storage media, and/or further system components.

By way of example, FIG. 10 shows an arrangement of two storage media 22, for example hard disks, in a supporting structure 21 which is suspended via four wire cable vibration dampers 23 on the inside of the housing of the flight data plotter 1, with vibration damping. Likewise by way of example, FIG. 10 shows a further system component 24 which is arranged on the outside of the supporting structure 21. The further system component 24 in the exemplary embodiment is in the form of a controller. System components which are not sensitive to impacts and vibration can also be fitted directly to the housing of the flight data recorder 1.

The vibration-damped arrangement of the storage media 22 makes it possible to use relatively simple and low-cost standard storage media, for example standard hard disks. It is also advantageous for the flight data recorder 1 not to have to be arranged n a separate impact-resistant transport container while being transported to or from the adapter 2. The flight data recorder 1 can be carried and transported by means of its handle 6 in a simple manner, because the storage media 22 are arranged with vibration damping.

1. A securing apparatus for a portable electronic unit to an adapter, which is electronically and/or mechanically connected to a physical unit, in particular an aircraft, wherein the adapter is provided with a locking device which has a control element that is mounted via a shaft, with the shaft being provided with an eccentric device, and with the eccentric device pushing the portable device which is inserted into the adapter to a locked position by operation of the control element beyond the dead point of the eccentric device.

2. The apparatus as claimed in claim 1, wherein the adapter and the portable unit each have connecting-link elements which are movable with. response to one another in order to assume the secured position, and which can be clamped or wedged to one another in the secured position.

3. The apparatus as claimed in claim 1, wherein the adapter has side guides which extend upward from a bottom surface of the adapter and surround at least one lower area of the portable unit, which is inserted into the adapter, at the sides.

4. The apparatus as claimed in claim 3, wherein the connecting-link elements of the adapter are arranged on the inside of the side guides.

5. The apparatus as claimed in claim 2, wherein the connecting-link elements of the portable unit are arranged on its outside.

6. The apparatus as claimed in claim 2, wherein the contact surfaces of the connecting-link elements which are provided for mutual wedging or clamping are in the form of wedges.

7. The apparatus as claimed in claim 1, wherein the eccentric device has two eccentric elements which are each arranged in the area of one end of the shaft.

8. The apparatus as claimed in claim 7, wherein each eccentric element is associated with one horizontal contact surface and one vertical contact surface of the portable unit.

9. The apparatus as claimed in claim 7, wherein the eccentric elements each have at least two projections.

10. The apparatus as claimed in claim 7, wherein the eccentric elements are in the form of curved rings which are arranged eccentrically on the shaft and each have two radially projecting projections.

11. The apparatus as claimed in claim 9, wherein the projections are arranged and/or formed in such a way that the rotary movement of the shaft allows a two-stage movement sequence to be transmitted to the portable unit.

12. The apparatus as claimed in claim 11, wherein, in the first stage of the rotary movement, those projections on the eccentric elements which are in each case located at the front in the rotation direction of the shaft make contact with the respectively associated vertical contact surfaces on the portable unit, and push the portable unit to the locked position.

13. The apparatus as claimed in claim 11, wherein, in the second stage of the rotary movement, those projections on the eccentric elements which are in each case located at the rear in the rotation direction of the shaft make contact with the horizontal contact surfaces on the portable unit and raise the portable unit in such a way that the portable unit is clamped at right angles to the Insertion direct on, in such a way that the portable unit cannot move in any direction below an increasing holding force.

14. The apparatus as claimed in claim 6, wherein the wedge-shaped connecting-link elements are arranged with respect to one another such that they are clamped or wedged to one another by the raising of the portable unit.

15. The apparatus as claimed in claim 1, wherein the shaft is in the form of an elastic or flexible shaft.

16. The apparatus as claimed in claim 1, wherein the shaft is arranged on at least one spring element which prestresses the shaft essentially vertically in the direction of the horizontal contact surfaces.

17. The apparatus as claimed in claim 16, wherein the spring element is in the form of a plate spring on which the shaft rests or is mounted.

18. The apparatus as claimed in claim 16, wherein the shaft is in the form of a stiff shaft.

19. The apparatus as claimed in claim 1, wherein the shaft is mounted such that it can move or can be adjusted.

20. The apparatus as claimed in claim 1, wherein the shaft has a rectangular cross section.

21. The apparatus as claimed in claim 1, wherein the adapter and the portable unit are provided with electronic coupling elements which make contact with one another in the secured position.

22. The apparatus as claimed in claim 1, wherein the portable electronic unit is in the form of a flight data recorder.

23. A securing apparatus for a portable storage device in an aircraft, with the storage device having a housing in which at least one storage medium is arranged, comprising an adapter which is suitable for holding the storage device, with the adapter being electronically and/or mechanically connected to the aircraft.

24. The apparatus as claimed in claim 23, wherein the adapter and the storage device are provided with electronic coupling elements which make contact with one another in the secured position.

25. The apparatus as claimed in claim 23, wherein the storage device has two or more storage media and/or further system components.

26. The apparatus as claimed in claim 23, wherein the storage media are arranged or suspended in the housing of the storage device with vibration damping.

27. The apparatus as claimed in claim 23, wherein the storage device is in the form of a flight data recorder in which data obtained from a digital camera can be stored during a photographic flight of the aircraft.
